(19) United States
(12) Patent Application Publication
(10) Pub. No.: US 2024/0149420 A1
(43) Pub. Date: May 9, 2024

(54) ROTARY HAMMER

(71) Applicant: MILWAUKEE ELECTRIC TOOL CORPORATION, Brookfield, WI (US)

(72) Inventor: Spencer D. Stingl, Wauwatosa, WI (US)

(21) Appl. No.: 18/502,137

(22) Filed: Nov. 6, 2023

Related U.S. Application Data
(60) Provisional application No. 63/387,024, filed on Dec. 12, 2022.
(60) Provisional application No. 63/382,838, filed on Nov. 8, 2022.

(51) Int. Cl. B25D 11/10; B25D 17/06

(52) U.S. Cl. CPC B25D 11/104; B25D 17/06; B25D 16/006

(57) ABSTRACT

A rotary hammer includes a motor, a spindle coupled to the motor for receiving torque, a piston received within the spindle for reciprocation, a striker received within the spindle for reciprocation in response to reciprocation of the piston, and an anvil received within the spindle and positioned between the striker and the tool bit. The anvil imparts axial impacts to the tool bit in response to reciprocation of the striker. A reciprocation mechanism is coupled to the motor to reciprocate the piston along a reciprocation axis. The reciprocation mechanism includes a camshaft fixedly coupled to the piston, a cam groove in the camshaft, a cam ball received by the cam groove, and a rotatable hub on which the cam ball is carried. The rotatable hub is configured to receive torque from the motor and reciprocate the camshaft in response to relative rotation between the cam ball and the camshaft.

### CROSS-REFERENCE TO RELATED APPLICATIONS

This application claims priority to co-pending U.S. Provisional Patent Application No. 63/387,024 filed on Dec. 12, 2022 and co-pending U.S. Provisional Patent Application No. 63/382,838 filed on Nov. 8, 2022, the entire contents of each of which are incorporated herein by reference.

### FIELD OF THE INVENTION

The present invention relates to power tools, and more particularly to rotary hammers.

### BACKGROUND OF THE INVENTION

Rotary hammers typically include a rotatable spindle, a reciprocating piston within the spindle, and a striker that is selectively reciprocable within the piston in response to an air pocket developed between the piston and the striker. Rotary hammers also typically include an anvil that is impacted by the striker when the striker reciprocates within the piston. The impact between the striker and the anvil is transferred to a tool bit, causing it to reciprocate for performing work on a work piece.

### SUMMARY OF THE INVENTION

The invention provides, in one aspect, a rotary hammer adapted to impart axial impacts to a tool bit. The rotary hammer includes a motor, a spindle coupled to the motor for receiving torque from the motor, a piston at least partially received within the spindle for reciprocation therein, a striker received within the spindle for reciprocation in response to reciprocation of the piston, and an anvil received within the spindle and positioned between the striker and the tool bit. The anvil imparts axial impacts to the tool bit in response to reciprocation of the striker. A reciprocation mechanism is operatively coupled to the motor and configured to reciprocate the piston along a reciprocation axis. The reciprocation mechanism includes a camshaft fixedly coupled to the piston, a cam groove in camshaft, a cam ball received by the cam groove, and a rotatable hub on which the cam ball is carried. The rotatable hub is configured to receive torque from the motor and to reciprocate the camshaft in response to relative rotation between the cam ball and the camshaft.

The invention provides, in another aspect, a rotary hammer adapted to impart axial impacts to a tool bit. The rotary hammer includes a housing, a motor positioned within the housing, a spindle positioned within the housing and coupled to the motor for receiving torque from the motor, a piston at least partially received within the spindle for reciprocation therein, a striker received within the spindle for reciprocation in response to reciprocation of the piston, and an anvil received within the spindle and positioned between the striker and the tool bit. The anvil imparts axial impacts to the tool bit in response to reciprocation of the striker. A reciprocation mechanism is operatively coupled to the motor and configured to reciprocate the piston along a reciprocation axis coaxial with the spindle. The reciprocation mechanism includes a bearing fixed relative to the housing and a camshaft rotatably fixed and reciprocable relative to the bearing along the reciprocation axis. The camshaft is fixedly coupled to the piston and includes a sinusoidal cam groove that extends continuously about a circumference thereof. The sinusoidal cam groove includes alternating peaks and valleys relative to the reciprocation axis. A cam ball is received by the sinusoidal cam groove, and a driver is rotatable via the motor and drivably engaged with the cam ball to reciprocate the camshaft. In response to rotation of the driver, the cam ball moves along the sinusoidal groove and rotates about the reciprocation axis. The sinusoidal cam groove converts rotational motion of the cam ball to reciprocating movement of the piston along the reciprocation axis.

The invention provides, in another aspect, a rotary hammer adapted to impart axial impacts to a tool bit. The rotary hammer includes a motor, a spindle coupled to the motor for receiving torque from the motor, a piston at least partially received within the spindle for reciprocation therein, a striker received within the spindle for reciprocation in response to reciprocation of the piston, and an anvil received within the spindle and positioned between the striker and the tool bit. The anvil imparts axial impacts to the tool bit in response to reciprocation of the striker. The rotary hammer further includes a reciprocation mechanism operatively coupled to the motor and configured to reciprocate the piston along a reciprocation axis. The reciprocation mechanism includes a pin fixedly coupled to the piston, and a rotatable hub having an inner surface and a cam groove in the inner surface in which the pin is received. The rotatable hub is configured to receive torque from the motor and reciprocate the piston in response to relative rotation between the hub and the pin.

Other features and aspects of the invention will become apparent by consideration of the following detailed description and accompanying drawings.

### BRIEF DESCRIPTION OF THE DRAWINGS

FIG. 1 is a front perspective view of a rotary hammer in accordance with an embodiment of the invention.

FIG. 2 is a cross-sectional view of the rotary hammer of FIG. 1 through line 2-2 in FIG. 1.

FIG. 3 a perspective view of the rotary hammer of FIG. 1, with the housing removed and illustrating an inner frame, a portion of a transmission, and a reciprocating mechanism.

FIG. 4 is another perspective view of the rotary hammer of FIG. 1, with the housing removed and illustrating the inner frame, the portion of the transmission, and the reciprocating mechanism.

FIG. 5 is a cross-sectional view of an inner frame and a portion of the reciprocating mechanism of the rotary hammer of FIG. 1 along the axis 5-5 of FIG. 3.

FIG. 6 is a perspective view of the reciprocation mechanism of the rotary hammer shown in FIG. 1.

FIG. 7 is an exploded view of the reciprocation mechanism of the rotary hammer shown in FIG. 1.

FIG. 8 is a schematic view of the movement of a camshaft of the reciprocation mechanism of the rotary hammer shown in FIG. 1.

FIG. 9 is a cross-sectional view of the rotary hammer of FIG. 1 through line 2-2 in FIG. 1 and illustrating a reciprocating mechanism according to another embodiment.

FIG. 10 is a perspective view of the reciprocation mechanism of FIG. 9.

FIG. 11 is an exploded view of the reciprocation mechanism of FIG. 9.

FIG. 12 is a perspective view of the reciprocation mechanism of FIG. 9 with a portion removed.

FIG. 13 is a cross-sectional view of a portion of the reciprocation mechanism of FIG. 9 along the line 13-13 of FIG. 10.

FIG. 14 is a cross-sectional view of a portion of the reciprocation mechanism of FIG. 9 along the line 14-14 of FIG. 10.

FIG. 15 is a perspective of a portion of the reciprocation mechanism of FIG. 9.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

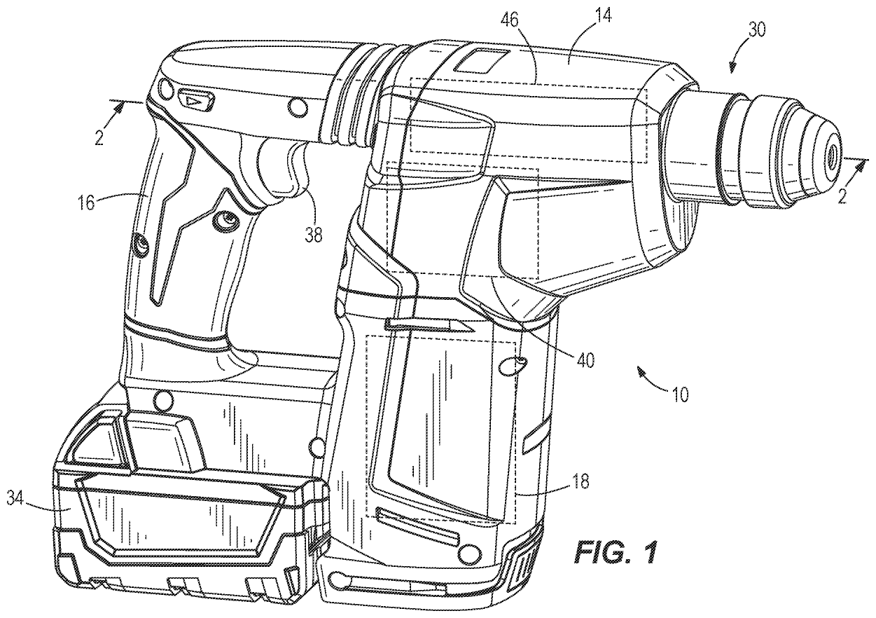

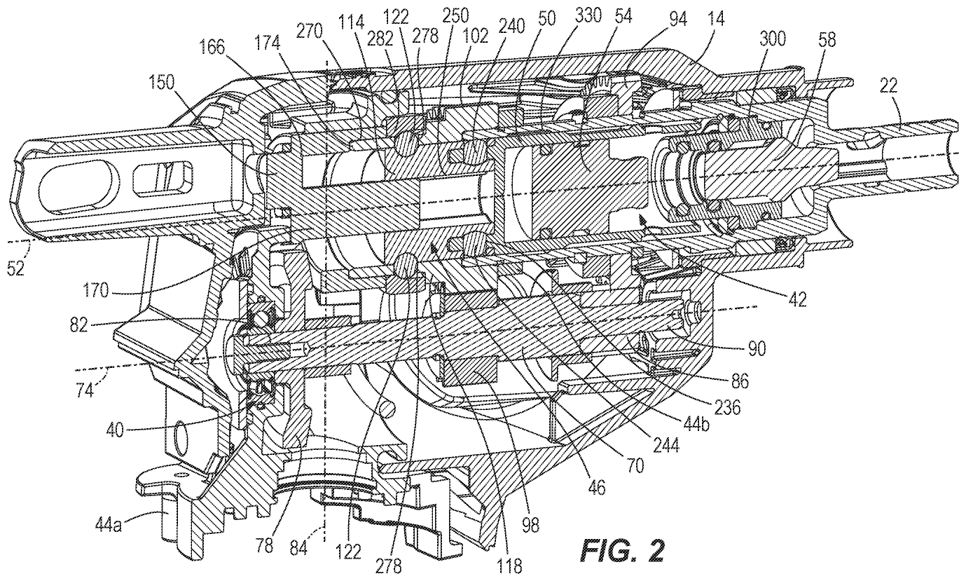

FIG. 1 illustrates a rotary hammer 10 including a housing 14 and a handle 16 coupled to the housing 14. The rotary hammer 10 further includes a motor 18 (FIG. 1) disposed within the housing 14 and a rotatable spindle 22 (FIG. 2) coupled to the motor 18 for receiving torque from the motor 18. A tool bit (not shown) may be secured to the spindle 22 for co-rotation with the spindle 22 (e.g., using a spline-fit). The rotary hammer 10 also includes a bit retention assembly 30 (FIG. 1) coupled for co-rotation with the spindle 22 to facilitate quick removal and replacement of different tool bits.

In the illustrated embodiment of the rotary hammer 10, the motor 18 is configured as a brushless direct current (BLDC) motor 18 that receives electrical current from an on-board power source 34 (e.g., a battery pack 34, FIG. 1). The battery pack 34 may include any of a number of different nominal voltages (e.g., 12V, 18V, etc.), and may be configured having any of a number of different chemistries (e.g., lithium-ion, nickel-cadmium, etc.). Alternatively, the motor 18 may be powered by a remote power source (e.g., a household electrical outlet) through a power cord. The motor 18 is selectively activated by depressing a trigger 38 which, in turn, actuates a switch. The switch may be electrically connected to the motor 18 via a top-level or master controller, or one or more circuits, for controlling operation of the motor 18.

With reference to FIG. 2, the rotary hammer 10 also includes a transmission 40 for transferring torque from the motor 18 to the spindle 22, an impact mechanism 42 driven by the transmission 40 for delivering repeated impacts to the tool bit, and a reciprocation mechanism 46 for converting torque received from the motor 18 to a reciprocating force acting on the impact mechanism 42. In the illustrated embodiment, the transmission 40 and the reciprocation mechanism 46 are at least partially supported by an inner frame or gear case 44a, 44b that is positioned within and supported by the housing 14. In the illustrated embodiment, the impact mechanism 42 includes a reciprocating piston 50 disposed within the spindle 22 and movable in a single stroke between a forward-most position within the spindle 22 and a rearward-most position within the spindle 22. The piston 50 is oriented along a reciprocation axis 52 and the reciprocation mechanism 46 reciprocates the piston 50 along the reciprocation axis 52. The impact mechanism 42 also includes a striker 54 that is selectively reciprocable within the spindle 22 in response to reciprocation of the piston 50, and an anvil 58 that is impacted by the striker 54 when the striker 54 reciprocates toward the tool bit. The impact between the striker 54 and the anvil 58 is transferred to the tool bit, causing it to reciprocate for performing work on a work piece. In the illustrated embodiment of the rotary hammer 10, an air pocket is developed between the piston 50 and the striker 54 when the piston 50 reciprocates within the spindle 22, whereby expansion and contraction of the air pocket induces reciprocation of the striker 54.

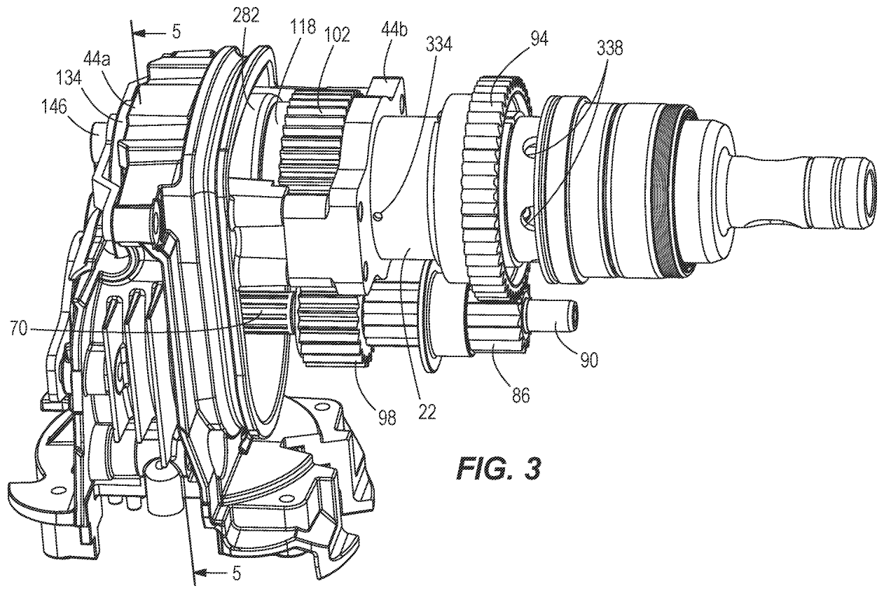

With continued reference to FIGS. 2 and 3, the transmission 40 includes an intermediate shaft 70 for transferring torque from the motor 18 to the spindle 22. The intermediate shaft 70 defines an axis 74 that is parallel to the reciprocation axis 52. A driven gear 78 is attached to a first end 82 of the intermediate shaft 70 and is engaged with a pinion (not shown) that is driven by the motor 18. In the illustrated embodiment, the axis 74 of the intermediate shaft 70 is oriented perpendicular to an axis 84 of the motor 18. In other embodiments, the motor 18 may be differently oriented relative to the transmission 40 and reciprocation mechanism 46. For example, in other embodiments, the axis 84 of the motor 18 may be parallel to the axis 74 of the intermediate shaft 70, and the axes 52, 74, 84 may be non-collinear relative to one another. The intermediate shaft 70 includes a first pinion 86 on a second end 90 of the intermediate shaft 70. The first pinion 86 is engaged with a first driven gear 94 attached to the spindle 22. The intermediate shaft 70 also includes a second pinion 98 that is positioned between the first end 82 and the second 90. The second pinion 98 is engaged with a second driven gear 102 that is part of the reciprocation mechanism 46.

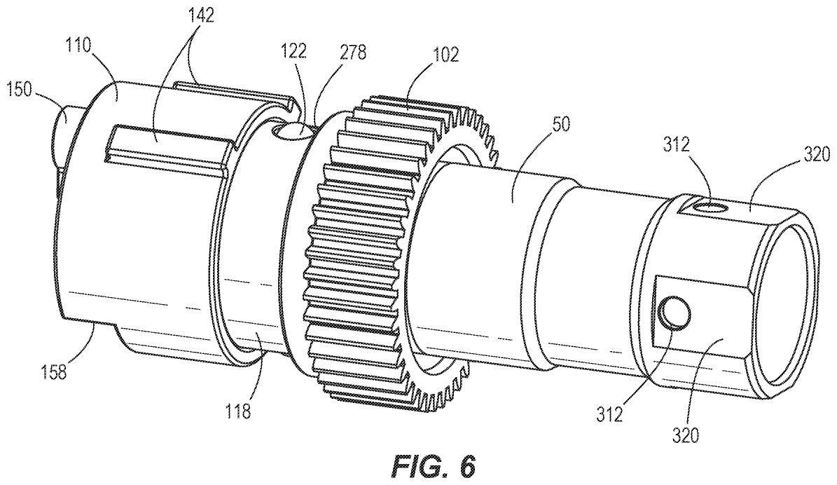

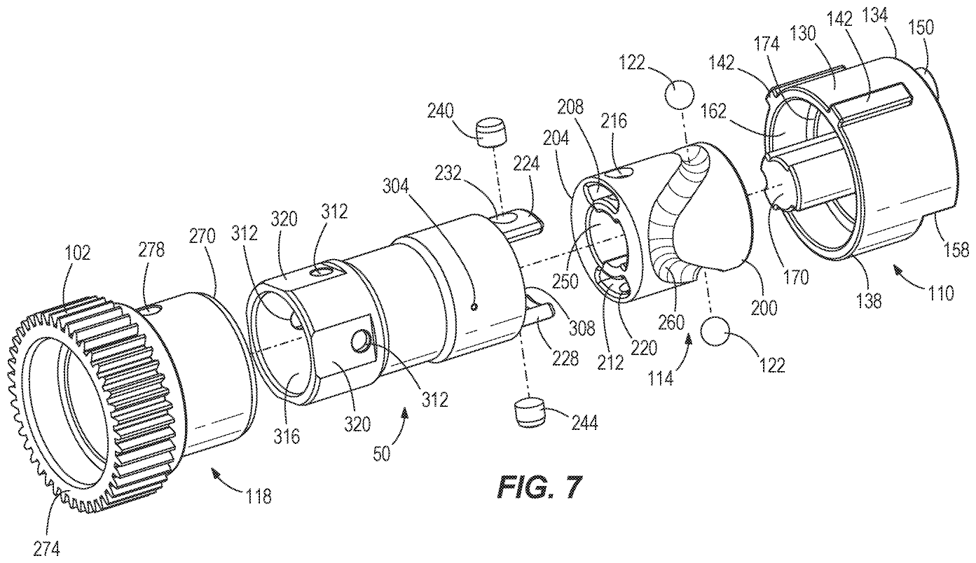

With reference to FIGS. 6-7, the reciprocation mechanism 46 includes a mount 110, a camshaft 114, a driver 118 (e.g., a hub), a cam ball 122, and the piston 50. In the illustrated embodiment, the driver 118 is integrally formed with (or otherwise coupled to) the second driven gear 102.

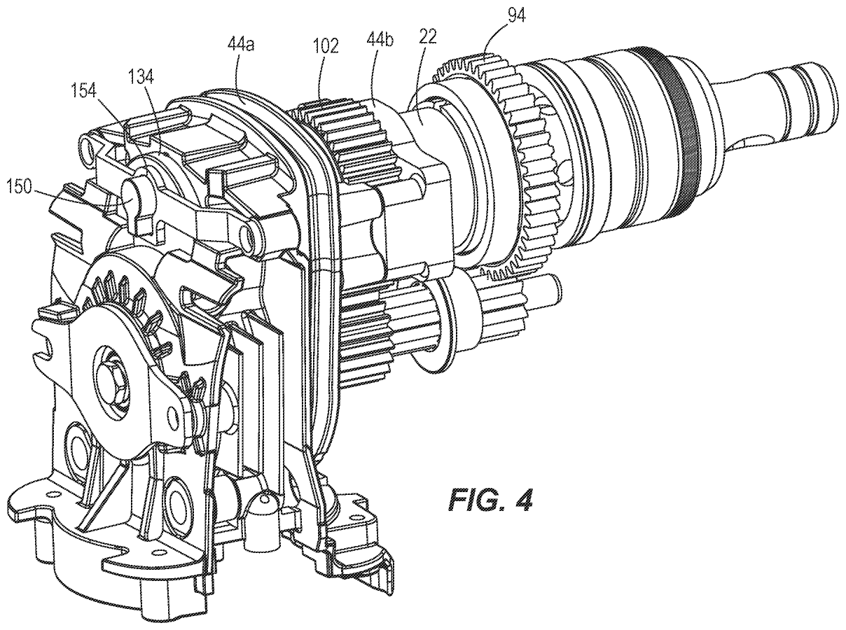

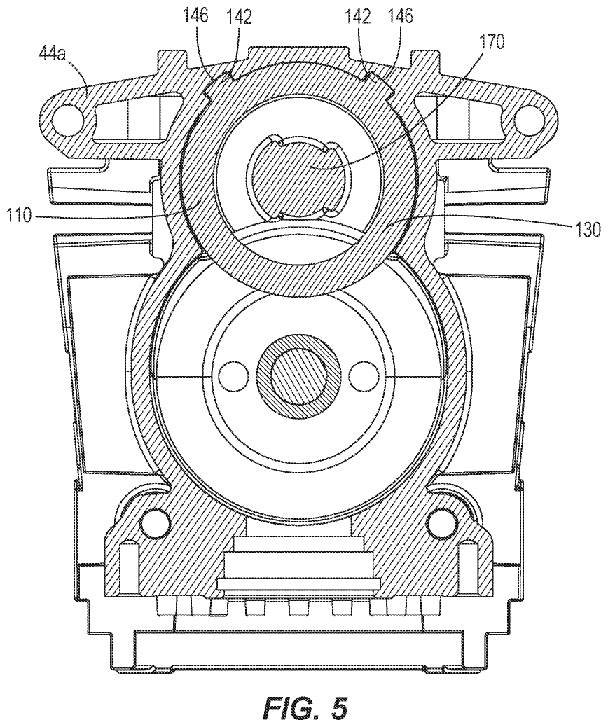

As shown in FIG. 5, the mount 110 is fixedly coupled to the inner frame 44a. With respect to FIGS. 5-7, the mount 110 includes a generally circumferential wall 130 that has a first end 134 and a second end 138. A pair of projections 142 extend from an outer surface of the circumferential wall 130 and are received in complementary grooves 146 (FIG. 5) in the inner frame 44a. A projection or key 150 extends from the first end 134 and is received in a complementary recess 154 (FIG. 4) in the inner frame 44a. A first recess 158 is defined in the first end 134 and is configured to accommodate the driven gear 78. A second recess 162 extends from the second end 138 towards the first end 134. The second recess 162 defines an inner wall 166 (FIG. 2). A shaft 170 is integrally formed with the inner wall 166, extends through the second recess 162, and projects beyond the second end 138 of the circumferential wall 130. The shaft 170 is spaced apart from the circumferential wall 130. The shaft 170 has a non-circular outer perimeter and cross-sectional shape. The shaft 170 is coaxial with the reciprocation axis 52. A ridge or lip 174 (FIGS. 2 and 7) extends from an inner surface of the circumferential wall 130 and is positioned between the first end 134 and the second end 138.

As will be discussed below and shown in FIGS. 2 and 7, the camshaft 114 is fixedly coupled to the piston 50 and, together, the camshaft 114 and the piston 50 are configured to reciprocate along the reciprocation axis 52.

With respect to FIG. 7, the camshaft 114 includes a first end 200 and an opposite, second end 204. A first bore 208 and an opposite, second bore 212 extend from the second end 204 towards the first end 200. A first radial aperture 216 is in communication with the first bore 208 and a second radial aperture 220 is communication with the second bore 212. The first bore 208 is configured to receive a first leg 224 extending from the rear of the piston 50 and the second bore 212 is configured to receive a second leg 228 extending from the rear of the piston 50. The first leg 224 of the piston 50 includes a first radial aperture 232 that is aligned with the first radial aperture 216 in the camshaft 114 when the first leg 224 is received in the first bore 208. The second leg 228 of the piston 50 includes a second radial aperture 236 (FIG. 2) that is aligned with the second radial aperture 220 of the camshaft 114 when the second leg 228 is received in the second bore 212. A first fastener 240 (e.g., a pin) is received in the aligned first radial apertures 216, 232 and a second fastener 244 (e.g., a pin) is received in the aligned second radial apertures 220, 236, and therefore the fasteners 240, 244 unitize the camshaft 114 to the piston 50 such that reciprocating movement of the piston 50 and camshaft 114 occur in unison. In the illustrated embodiment, the camshaft 114 is coupled to the piston 50 via the fasteners 240, 244 but in other embodiments the camshaft 114 may be coupled to the piston 50 in other ways. For example, the camshaft 114 may be coupled via threaded engagement to the piston 50 or the camshaft 114 may be integrally formed with the piston 50.

The camshaft 114 further includes an aperture 250 that extends from the first end 200 to the second end 204. The aperture 250 is configured to matingly receive and move (e.g., reciprocate, slide, translate) along the shaft 170 of the mount 110. That is, the aperture 250 has the same non-circular cross-sectional shape as the outer perimeter of the shaft 170, preventing relative rotation between the camshaft 114 and the shaft 170.

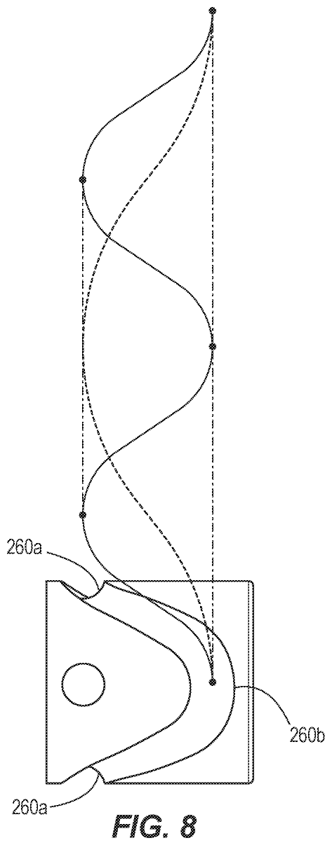

The camshaft 114 further includes a cam groove 260 in which dual, opposed cam balls 122 are received. In the illustrated embodiment, the cam groove 260 is continuous about the circumference of the camshaft 122. As shown in FIGS. 7 and 8, the cam groove 260 is generally sinusoidal. In the illustrated embodiment, the cam groove 260 has two peaks 260a and two valleys 260b (FIG. 8). In other embodiments, there may be more of fewer peaks and valleys or the cam groove 260 may have other configurations. In the illustrated embodiment, there are two cam balls 122, one on each side of the reciprocation axis 52. In other embodiments, there may be a single cam ball 122 or more than two cam balls 122. Also, in some embodiments, the cam balls 122 and the cam groove 260 each have a diameter of between 2 mm and 10 mm. In other embodiments, the cam balls 122 and the cam groove 260 each have a diameter of between 4 mm and 8 mm. In still other embodiments, the cam balls 122 and the cam groove 260 each have a diameter of 5 mm to 6 mm.

With reference to FIGS. 2 and 7, the driver 118 is axially constrained by the mount 110 and the inner frame 44b, but rotatable relative to the camshaft 114. The driver 118 is configured to reciprocate the camshaft 114. The driver 118 has a first end 270 and a second end 274 and is generally hollow (FIG. 7). The first end 270 is received within the second recess 162 of the mount 110 and abuts the ridge 174. The second end 274 receives a portion of the spindle 22. The second end 274 includes the second driven gear 102. The driver 118 includes two radial apertures 278, with the respective cam balls 122 being received therein. The cam balls 280 are therefore carried by the driver 118. A generally cylindrical retaining ring 282 surrounds the driver 118 over the apertures 278 to maintain the cam balls 122 within the cam groove 260.

When received within the respective radial apertures 278, the cam balls 122 are rotationally unitized with the driver 118 such that rotation of the driver 118 causes the cam balls 122 to rotate (i.e., orbit) about the reciprocating axis 52. And, movement of the cam balls 122 within the cam groove 260 allows for relative axial movement of the camshaft 114 relative to the mount 110 along the along the reciprocation axis 52. The rotatable driver 118 is configured to receive torque from the motor 18 and reciprocate the camshaft 114 in response to relative rotation between the cam ball 122 and the camshaft 114. Specifically, rotation of the intermediate shaft 70 rotates the driver 118 via engagement between the second pinion 98 and the second driven gear 102. Rotation of the driver 118 causes the cam balls 122 to move within the cam groove 260. Movement of the cam balls 122 within the cam groove 260 causes axial reciprocating movement of the camshaft 114. That is, in response to rotation of the driver 118, the cam balls 280 move along the sinusoidal cam groove 260 and rotate about the reciprocation axis 52. The sinusoidal cam groove 260 converts rotational motion of the cam balls 280 to reciprocating movement of the piston 50 along the reciprocation axis 52. In the illustrated embodiment, one stroke is applied to the piston 50 when the cam balls 260 are positioned in each valley 260b of the cam groove 260. Because the cam groove 260 has two valleys 260b, two strokes are applied to the piston 50 per revolution of the camshaft 114. In the illustrated embodiment, the cam groove 260 is not perfectly sinusoidal as there is flat section in the middle, as shown in FIG. 8.

Although not shown in detail, the rotary hammer 10 includes a mode selection mechanism with a mode selection actuator that is accessible by an operator of the hammer 10 to switch the rotary hammer 10 between a “drill” mode, in which the impact mechanism 42 is deactivated, and a “hammer-drill” mode, in which the impact mechanism 42 is activated.

When the tool bit of the rotary hammer 10 is depressed against a workpiece, the tool bit pushes the striker 54 (via the anvil 58) rearward toward an “impact” position. During operation of the rotary hammer 10 in the hammer-drill mode, the piston 50 reciprocates within the spindle 22 to draw the striker 54 rearward and then accelerate it towards the anvil 58 for impact. When the tool bit is removed from the workpiece, the rotary hammer 10 may transition from the hammer-drill mode to an “idle” mode, in which the striker 54 is captured by a retainer 300 (FIG. 2) in the idle position and prevented from further reciprocation within the piston 50.

With reference to FIG. 7, the piston 50 includes an orifice 304 disposed proximate a rear, closed end 308 of the piston 50 and an idle port 312 disposed proximate a front, open end 316 of the piston 50. The legs 224, 228 extend from the closed end 308 of the piston 50, as shown in FIG. 7. The piston 50 also includes a notch 320 formed in the outer periphery of the piston 50 adjacent the front open end 316. The idle port 312 coincides with the notch 320. In the illustrated embodiment, there are multiple idle ports 312 and multiple notches 320. In the illustrated embodiment, there are four idle ports 312 (only three of which are shown) and there are four corresponding notches 320 (only three of which are shown). In other embodiments, there may be more or fewer idle ports 312 and notches 320. The spindle 22 includes an annular groove 330 (FIG. 2) formed in the inner periphery of the spindle 22 and a vent port 334 (FIG. 3) positioned in the groove 330. The spindle 22 further includes additional vent ports 338 (FIG. 3) that fluidly communicate the interior of the spindle 22 with the atmosphere.

As mentioned above, when the tool bit of the rotary hammer 10 is depressed against a workpiece, the tool bit pushes the striker 54 (via the anvil 58) rearward toward the “impact” position (shown in FIG. 2) in which the idle port 312 in the piston 50 is blocked by the striker 54, thereby forming the air pocket between the striker 54 and the reciprocating piston 50. As operation of the rotary hammer 10 initially commences (i.e., within one second or less after the rotary hammer 10 is initially activated), the orifice 304 in the piston 50 may remain uncovered by the striker 54 for brief intervals while the orifice 304 is aligned with the annular groove 330. During these intervals, air may be drawn into the interior chamber of the piston 50 or expelled from the interior chamber, depending upon the air pressure within the interior chamber just prior to activation of the rotary hammer 10, to allow the air pocket to achieve “steady state” in which an approximately constant air mass produces an approximately constant cyclical force on the striker 54.

During steady-state operation of the rotary hammer 10 in the hammer-drill mode, the piston 50 reciprocates, via the reciprocation of the camshaft 114, within the spindle 22 to draw the striker 54 rearward and then accelerate it towards the anvil 58 for impact. The movement of the striker 54 within the piston 50 is such that the orifice 304 is blocked by the striker 54 while the orifice 304 is aligned with the annular groove 330 in the spindle 22, thereby maintaining the existence of the air pocket. At any instance when the orifice 304 is unblocked by the striker 54, the orifice 304 is misaligned with the annular groove 330, thereby preventing escape of the air from the interior chamber of the piston 50 and maintaining the existence of the air pocket.

When the tool bit is removed from the workpiece, the rotary hammer 10 may transition from the hammer-drill mode to the idle mode, in which the striker 54 is prevented from further reciprocation within the piston 50. During the transition from hammer-drill mode to idle mode, the air pocket established between the piston 50 and the striker 54 is de-pressurized in a staged manner as the orifice 304 in the piston 50 is aligned with the annular groove 330, thereby permitting pressurized air within the piston 50 to vent through the orifice 304 and the vent port 334 in the annular groove 330 of the spindle 22. When in idle mode, the piston 50 is positioned such that the idle port 312 is uncovered, thereby permitting the remainder of the pressurized air within the piston 50 to vent through the idle ports 312, through the space defined between the notch 320 and the spindle 22, and through the additional vent ports 338 in the spindle 22 to atmosphere. Continued reciprocation of the piston 50 is therefore permitted without drawing the striker 54 back to the impact position because the orifice 304 remains unblocked when it is aligned with the annular groove 330 in the spindle 22. Rather, air is alternately drawn and expelled through the orifice 304 and the idle port 312 while the piston 50 reciprocates. Depressing the tool bit against the workpiece to push the anvil 58 and the striker 54 rearward causes the rotary hammer 10 to transition back to the hammer-drill mode.

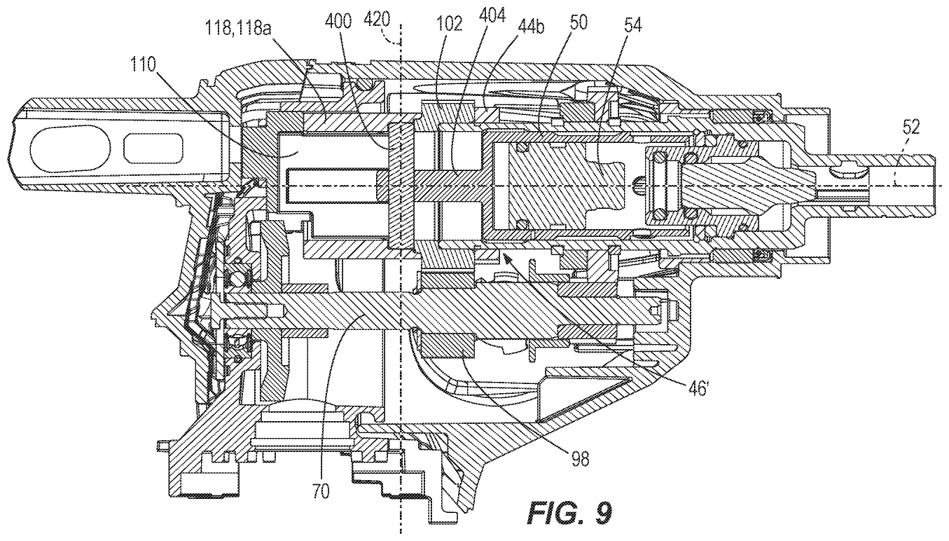

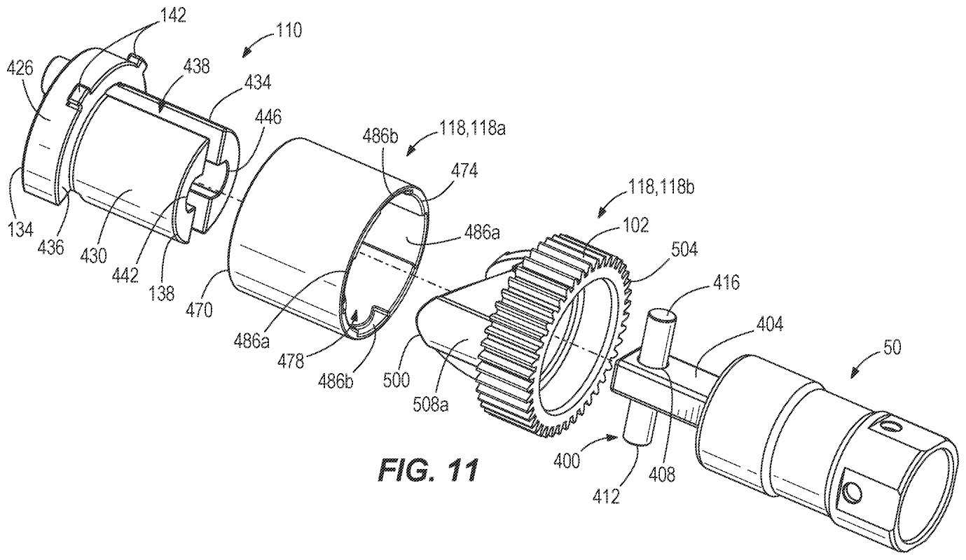

FIGS. 9-15 illustrate a reciprocation mechanism 46′ according to another embodiment. The reciprocation mechanism 46′ is similar to the reciprocation mechanism 46′ of FIGS. 6-7, and therefore like reference structure will be indicated with like reference numerals and only the differences will be discussed herein. As shown in FIGS. 9 and 11, the reciprocation mechanism 46′ includes the mount 110, the driver 118 (e.g., a rotatable hub), a pin 400, and the piston 50. In the illustrated embodiment, the piston 50′ includes an extension or a projection 404. A distal end of the projection 404 includes an aperture 408 extending therethrough and the pin 400 extends through the aperture 400. The pin 400 includes a first end 412 and a second end 416 opposite the first end 412. The pin 400 is oriented along a pin axis 420 that is perpendicular to the reciprocation axis 52 (FIG. 9).

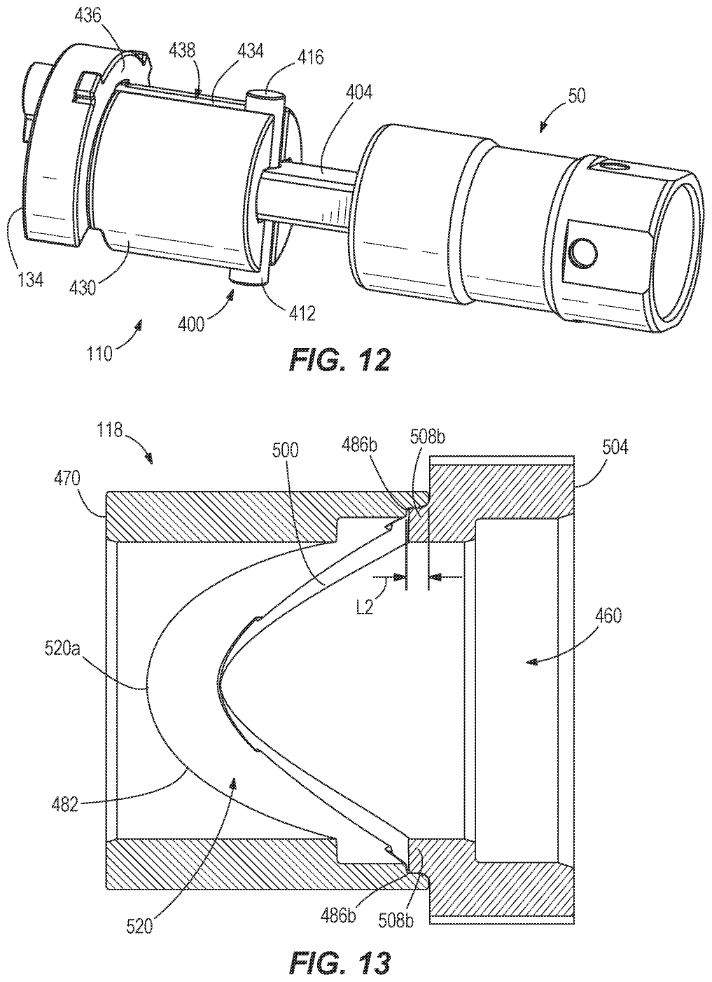

As shown in FIG. 11, the mount 110 includes a body 426 at or adjacent the first end 134. The mount 110′ further includes a first portion 430 and a second portion 434, each of which extends from a surface of the body 426 to the second end 138. The first portion 430 and the second portion 434 are spaced apart from a peripheral edge of the body 426, such that the surface also defines a lip 436 between the first end 134 and the second end 138. The first portion 430 and the second portion 434 are spaced apart from one another by a gap or slot 438. The first portion 430 and the second portion 434 are located on opposite sides of the reciprocation axis 52. Accordingly, a plane extending through the slot 438 contains the reciprocation axis 52. The first portion 430 includes a recess 442 that opens towards the slot 438 and the second portion 434 includes a recess 446 that opens towards the slot 438. The recesses 442, 446 also face one another and are generally aligned. The mount 110 rotationally constrains the piston 50 (e.g., the projection 404) and the pin 400. In this way, opposite sides of the projection 404 are received within the aligned recesses 442, 446 and the pin 400 is received within the slot 438. As shown in FIG. 12, the first and second ends 412, 416 of the pin 400 extend outwardly from the mount 110.

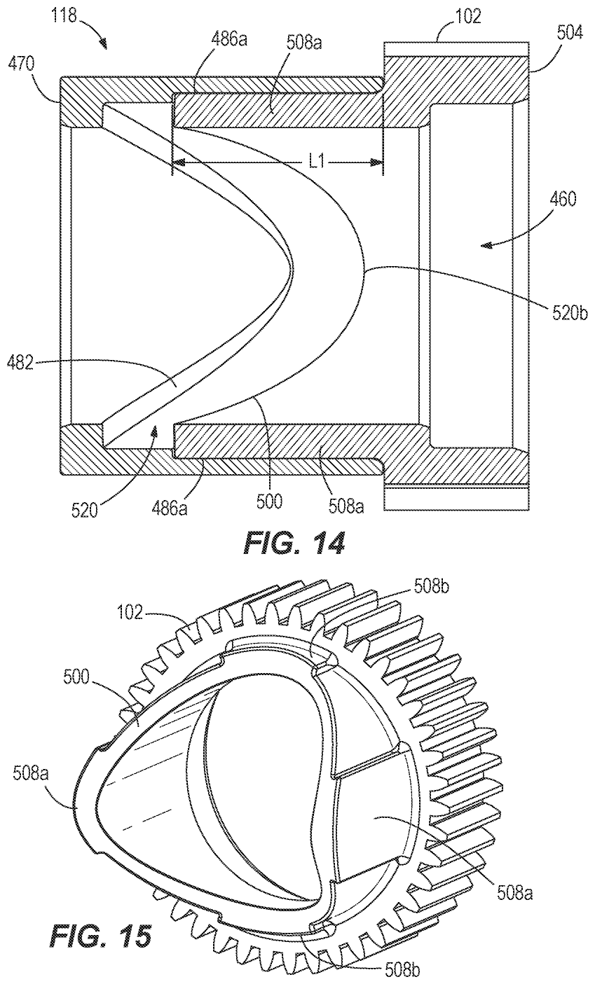

Further with respect to FIG. 11, in the illustrated embodiment, the driver 118 includes a first portion 118a and a second portion 118b that are coupled to one another and define an aperture 460 (FIGS. 13-14) extending therethrough. The second portion 118b is integrally formed with (or otherwise coupled to) the second driven gear 102.

As shown in FIG. 11, the first portion 118a includes a cylindrical body that is hollow and includes a first end 470 and a second end 474 opposite the first end 470. A recess 478 in an inner surface of the cylindrical body extends from the second end 474 towards the first end 470. The recess 478 defines a lip 482 (FIGS. 13-14) positioned between the first end 470 and the second end 474. The lip 482 has a generally undulating shape (e.g., sinusoidal shape) that extends circumferentially about the inner surface. A plurality of grooves 486a, 486b is defined in the inner surface and extend from the second end 474 toward the first end 470. Some of the grooves 486a have a first length L1 (FIG. 14) and some of the grooves 486b have a second shorter length L2 (FIG. 13).

The second portion 118b includes a generally cylindrical body that is hollow and includes a first end 500 and second end 504 opposite the first end 500. The first end 500 defines a generally undulating shape (e.g., sinusoidal shape) that extends circumferentially about the first end 500. The second driven gear 102 is positioned at or adjacent the second end 504. A plurality of projections 508a, 508b are formed on the outer surface of the second portion 118b. Each of the plurality of projections 508a, 508b is complementary to one of the plurality of grooves 486a, 486b in the first portion 118a. Accordingly, some of the projections 508a have the first length L1 and some of the projections 508b have the second shorter length L2.

The second portion 118b is coupled to the first portion 118a via splined engagement (e.g., spline-fit). Specifically, each of the projections 508a, 508b is received in a complementary one of the plurality of grooves 486a, 486b. The projections 508a with the first length L1 are received in the corresponding grooves 486a with the first length L1, while the projections 508b with the second length L2 are received within the corresponding grooves 486b with the second length L2. When coupled, the lip 482 of the first portion 118a and the first end 500 of the second portion 118b are spaced apart from one another by a cam groove 520 (e.g., a slot or a gap; FIG. 13). Accordingly, together the first portion 118a (e.g., the lip 482 thereof) and the second portion 118b (e.g., the first end 500 thereof) define a generally undulating cam groove 520 (e.g., sinusoidal cam groove) that extends circumferentially about an inner surface of the driver 118. In the illustrated embodiment, the cam groove 520 (and therefore each of the lip 482 of the first portion 118a and the first end 500 of the second portion 118b) has two peaks 520a (only one of which is shown in FIG. 13) and two valleys 520b (only one of which is shown in FIG. 14). In other embodiments, there may be more or fewer peaks 520a and valleys 520b, or the cam groove 520 (and therefore each of the lip 482 of the first portion 118a and the first end 500 of the second portion 118b) may have other configurations.

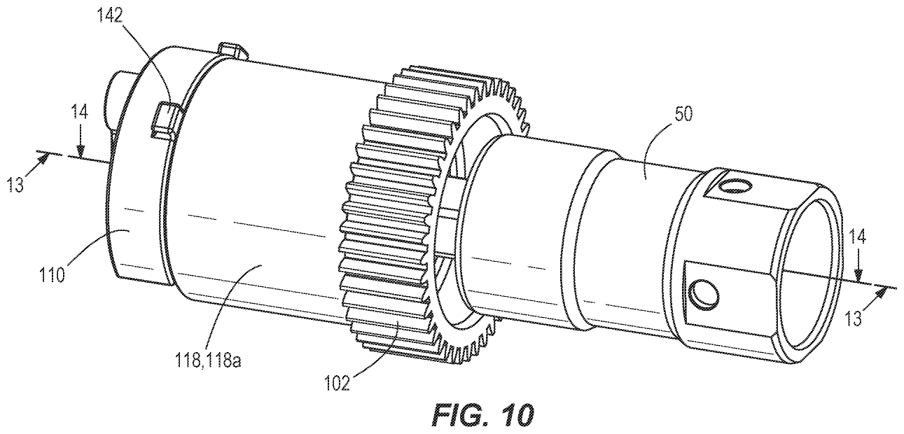

As shown in FIGS. 9 and 10, the driver 118 receives at least a portion of the mount 110, the projection 404 of the piston 50, and the pin 400. Specifically, the first portion 430 and the second portion 434 of the mount 110 are received within the aperture 460 of the driver 118. Moreover, the first end 470 of the first portion 118a abuts the lip 436 of the mount 110. The first end 412 and the second end 416 of the pin 400 are received in the cam groove 520 of the driver 118.

With reference to FIG. 9, the driver 118 is axially constrained by the mount 110 and the inner frame 44b, but rotatable relative to the mount 110. The driver 118 is configured to axially reciprocate the piston 50, via engagement with the pin 400. When the first and second ends 412, 416 are received in the cam groove 520, rotation of the driver 118 causes the first and second ends 412, 416 of the pin 400 move along a path created by the cam groove 520. And, movement of the pin 400 within the cam groove 520 allows for relative axial movement of the pin 400 and projection 404 of the piston 50 relative to the mount 110 along the reciprocation axis 52. The rotatable driver 118 is configured to receive torque from the motor 18 and reciprocate the projection 404 (via the pin 400) in response to relative rotation between the driver 118 and the mount 110. Specifically, rotation of the intermediate shaft 70 rotates the driver 118 via engagement between the second pinion 98 and the second driven gear 102. Rotation of the driver 118 causes the first and second ends 412, 416 of the pin 400 to move within the cam groove 520. Movement of the first and second ends 412, 416 of the pin 400 causes axial reciprocating movement of the projection 404, and therefore the piston 50. That is, in response to rotation of the driver 118, the first and second ends 412, 416 of the pin 400 move along the sinusoidal cam groove 520. The sinusoidal cam groove 520 converts rotational motion of the driver 118 to reciprocating movement of the piston 50 along the reciprocation axis 52. In the illustrated embodiment, one stroke is applied to the piston 50 when the first and second ends 412, 416 of the pin 400 slide within the cam groove 520 from one of the valleys 520b into one of the peaks 520a. Because the cam groove 520 has two valleys 520b and two peaks 520a, two strokes are applied to the piston 50 per revolution of the driver 118. In the illustrated embodiment, the cam groove 520 may not be perfectly sinusoidal as it may include a flat section in the middle, similar to the embodiment of FIGS. 6-7.

Various features of the invention are set forth in the following claims.

What is claimed is:

1. A rotary hammer adapted to impart axial impacts to a tool bit, the rotary hammer comprising:
a motor;
a spindle coupled to the motor for receiving torque from the motor;
a piston at least partially received within the spindle for reciprocation therein;
a striker received within the spindle for reciprocation in response to reciprocation of the piston;
an anvil received within the spindle and positioned between the striker and the tool bit, the anvil imparting axial impacts to the tool bit in response to reciprocation of the striker; and
a reciprocation mechanism operatively coupled to the motor and configured to reciprocate the piston along a reciprocation axis, the reciprocation mechanism including
a camshaft fixedly coupled to the piston,
a cam groove in camshaft,
a cam ball received by the cam groove, and
a rotatable hub on which the cam ball is carried, the rotatable hub configured to receive torque from the motor and reciprocate the camshaft in response to relative rotation between the cam ball and the camshaft.

2. The rotary hammer of claim 1, wherein the cam groove is a continuous groove about a circumference of the camshaft.

3. The rotary hammer of claim 1, wherein the cam groove is a generally sinusoidal groove extending about the circumference of the camshaft.

4. The rotary hammer of claim 1, further comprising a housing and an inner frame, and wherein the reciprocation mechanism includes a bearing coupled to the inner frame, wherein the bearing is configured to rotatably constrain the camshaft, and wherein the camshaft is configured to translate relative to the bearing.

5. The rotary hammer of claim 4, wherein the bearing has a shaft that is aligned with the reciprocation axis and includes a non-circular outer perimeter, wherein the camshaft includes an aperture extending therethrough, and wherein a shape of the aperture is complementary to the outer perimeter of the shaft.

6. The rotary hammer of claim 1, wherein the driver includes a driven gear, wherein the rotary hammer further comprises a transmission configured to transfer torque from the motor to the spindle, and wherein the transmission includes a shaft having a drive gear that is configured to engage the driven gear to rotate the driver.

7. The rotary hammer of claim 6, wherein the shaft defines a shaft axis that is oriented parallel to the reciprocation axis.

8. A rotary hammer adapted to impart axial impacts to a tool bit, the rotary hammer comprising:
a housing;
a motor positioned within the housing;
a spindle positioned within the housing and coupled to the motor for receiving torque from the motor;
a piston at least partially received within the spindle for reciprocation therein;
a striker received within the spindle for reciprocation in response to reciprocation of the piston;
an anvil received within the spindle and positioned between the striker and the tool bit, the anvil imparting axial impacts to the tool bit in response to reciprocation of the striker; and
a reciprocation mechanism operatively coupled to the motor and configured to reciprocate the piston along a reciprocation axis coaxial with the spindle, the reciprocation mechanism including
a bearing fixed relative to the housing;
a camshaft rotatably fixed and reciprocable relative to the bearing along the reciprocation axis, the camshaft fixedly coupled to the piston and including a sinusoidal cam groove that extends continuously about a circumference thereof, the sinusoidal cam groove including alternating peaks and valleys relative to the reciprocation axis,
a cam ball received by the sinusoidal cam groove, and
a driver rotatable via the motor and drivably engaged with the cam ball to reciprocate the camshaft,
wherein in response to rotation of the driver, the cam ball moves along the sinusoidal groove and rotates about the reciprocation axis, the sinusoidal cam groove converting rotational motion of the cam ball to reciprocating movement of the piston along the reciprocation axis.

9. The rotary hammer of claim 8, wherein the sinusoidal cam groove includes two peaks and two valleys such that two strokes are applied to the piston per revolution of the driver.

10. The rotary hammer of claim 8, wherein the bearing has a shaft that is aligned with the reciprocation axis and includes a non-circular outer perimeter, wherein the camshaft includes an aperture extending therethrough, and wherein a shape of the aperture is complementary to the outer perimeter of the shaft.

11. The rotary hammer of claim 8, wherein the driver includes a driven gear, wherein the rotary hammer further comprises a transmission configured to transfer torque from the motor to the spindle, and wherein the transmission includes a shaft having a drive gear that is configured to engage the driven gear to rotate the driver.

12. The rotary hammer of claim 11, wherein the shaft defines a shaft axis that is oriented parallel to the reciprocation axis.

13. The rotary hammer of claim 8, wherein the cam ball is a first cam ball, and wherein the rotary hammer further comprises a second cam ball positioned in the sinusoidal cam groove opposite the first cam ball.

14. A rotary hammer adapted to impart axial impacts to a tool bit, the rotary hammer comprising:
a motor;
a spindle coupled to the motor for receiving torque from the motor;
a piston at least partially received within the spindle for reciprocation therein;
a striker received within the spindle for reciprocation in response to reciprocation of the piston;
an anvil received within the spindle and positioned between the striker and the tool bit, the anvil imparting axial impacts to the tool bit in response to reciprocation of the striker; and
a reciprocation mechanism operatively coupled to the motor and configured to reciprocate the piston along a reciprocation axis, the reciprocation mechanism including
a pin fixedly coupled to the piston, and
a rotatable hub having an inner surface and a cam groove in the inner surface in which the pin is received, the rotatable hub configured to receive torque from the motor and reciprocate the piston in response to relative rotation between the hub and the pin.

15. The rotary hammer of claim 14, further comprising a mount configured to receive the pin, wherein the mount is configured to allow axial movement of the pin, but prevent rotation of the pin.

16. The rotary hammer of claim 15, wherein the rotatable hub is configured to receive the mount and to rotate relative to the mount.

17. The rotary hammer of claim 14, wherein the cam groove is a sinusoidal cam groove that extends continuously about a circumference thereof.

18. The rotary hammer of claim 14, wherein the rotatable hub includes a first portion and a second portion coupled to the first portion, and wherein the cam groove is defined between the first portion and the second portion.

19. The rotary hammer of claim 18, wherein the cam groove is a sinusoidal cam groove that extends continuously about a circumference thereof.

20. The rotary hammer of claim 18, wherein the first portion and the second portion are coupled to one another via a spline-fit.
